(19) United States
(12) Patent Application Publication
(10) Pub. No.: US 2018/0133593 A1
(43) Pub. Date: May 17, 2018

(54) ALGORITHM FOR IDENTIFYING THREE-DIMENSIONAL POINT-OF-GAZE

(71) Applicant: FOVE, INC., San Mateo, CA (US)

(72) Inventor: Lochlainn Wilson, Tokyo (JP)

(21) Appl. No.: 15/501,930

(22) PCT Filed: Aug. 7, 2014
(86) PCT No.: PCT/JP2014/070954

§ 371 Date: Dec. 11, 2017

(51) Int. Cl. A63F 13/213; G06T 15/40; G06T 15/06; G06F 3/01

(52) U.S. Cl. CPC A63F 13/213; G06T 15/405; A63F 2300/66; G06F 3/013; A63F 2300/1087; G06T 15/06

(57) ABSTRACT

To accurately input a point-of-gaze of a user in a game engine expressing a three-dimensional space. A point-of-gaze calculation algorithm is configured such that data of lines of view of both eyes of a user is calculated using data from a camera (10) capturing an image of the eyes of the user, and a three-dimensional coordinate position within a three-dimensional space at which the user gazes is calculated on the basis of the gaze data of the user and three-dimensional data included in a system managed by the game engine.

### TECHNICAL FIELD

The present invention relates to a method of identifying a point-of-gaze of a user in a three-dimensional image.

### BACKGROUND ART

In a display device such as a head-mounted display (HMD), a device that tracks a gaze of a user is already known. However, there is an error between a point at which the user actually gazes and a gaze of the user recognized by the device, and the gaze of the user cannot be accurately identified.

In general, a device that performs simulation of communication with a character displayed by a machine is already known in simulation games and the like.

A user interface device that images the eyes of a user described in Patent Literature 1 is known. In this user interface device, a gaze of the user is used as an input means for the device.

Further, a device described in Patent Literature 2 is also known as an input device using a gaze of a user. In this device, an input using a gaze of a user is enabled by a user gaze position detection means, an image display means, and a means for detecting whether a gaze position matches an image.

In the related art, a device for simulation of communication using a virtual character in which a text input using a keyboard is used as a main input, and a pulse, a body temperature, or sweating is used as an auxiliary input, for example, as in Patent Literature 3, is known.

### CITATION LIST

### Patent Literature

Patent Literature 1: Japanese Unexamined Patent Application Publication No. 2012-008745

Patent Literature 2: Japanese Unexamined Patent Application Publication No. H09-018775

Patent Literature 3: Japanese Unexamined Patent Application Publication No. 2004-212687

### SUMMARY OF INVENTION

### Technical Problem

When a gaze of a user is tracked in a display including a head-mounted display, directions of pupils of both eyes of a user do not necessarily match a point at which the user gazes. A technology for identifying accurate coordinates of a point-of-gaze of a user is required.

When a person looks at an object with his or her eyes, a thickness of a crystalline lens is adjusted according to a distance to a target, and a focus is adjusted so that images of the target are clearly connected. Therefore, a target separate from a point of view is out of focus and appears blurred.

However, in a three-dimensional image of the related art, a three-dimensional effect is achieved by merely providing different images to both eyes, and a target separated from the point of view is in focus and viewed clearly.

In order to perform simulation of communication by a machine, it is essential to introduce a real communication element into a system for a simulation. In particular, in real communication, since a role of recognition of lines of view is great, how to introduce detection and determination of lines of view of a user into simulation is a problem.

Further, in real communication, it is also important that a direction of a face be toward a counterpart. How to detect, determine, and introduce this point into simulation is also a problem.

### Solution to Problem

The above object is achieved by a point-of-gaze calculation algorithm including calculating data of lines of view of both eyes of a user using data from a camera that images the eyes of the user, and collating the calculated data of the lines of view with depth data of a three-dimensional space managed by a game engine using a ray casting method or a Z-buffer method; and calculating a three-dimensional coordinate position in the three-dimensional space at which the user gazes.

The point-of-gaze calculation algorithm according to the present invention, preferably, includes introducing focus representation in a pseudo manner by applying blur representation with depth information to a scene at the coordinates using three-dimensional coordinate position information identified by the gaze detection algorithm.

In the point-of-gaze calculation algorithm according to the present invention, preferably, a target of interaction is displayed, and the point-of-gaze calculation algorithm includes determining that the user interacts with the target when a gaze of the user and a direction of the face match a specific portion of the target displayed on an image display unit for a predetermined time or more.

A simulation by a display device with a gaze detection function of the present invention includes: calculating a direction of the face of the user using data from a direction sensor that detects the direction of the face of the user; and determining that the user interacts with the target when the gaze of the user and the direction of the face match a specific portion of the target displayed on an image display unit for a predetermined time or more.

A simulation by a display device with a gaze detection function of the present invention includes: calculating a direction of the face of the user using data from a direction sensor that detects the direction of the face of the user; and determining that the user interacts with the target when the gaze of the user and the direction and a position of the face match a specific portion of the target displayed on the image display unit for a predetermined time or more.

A point-of-gaze calculation algorithm according to the present invention is incorporated into a head-mounted display (HMD) including an image display unit and a camera that captures an image of the eyes of a user, the image display unit and the camera being stored in a housing fixed to the head of the user.

### Advantageous Effects of Invention

In a three-dimensional image using a 3D image device such as an HMD, an error occurs between an actual point-of-gaze of a user and a calculated point-of-gaze because only imaging of the eyes of the user is performed when the point-of-gaze of the user is calculated. However, it is possible to accurately calculate the point-of-gaze of a user by calculating the point-of-gaze of the user through collation with an object in an image.

Blurring is applied to positions with a depth separated in an image space from a focus of the user in the image to provide a three-dimensional image. Therefore, it is essential to accurately calculate the focus of the user. An error that occurs between a focus at which the user actually gazes and a calculated focus because calculation of the focus involves only calculating a shortest distance point or an intersection point between lines of view of both eyes is corrected by the algorithm of the present invention.

According to the above configuration, if the simulation of communication is performed by the display device with a gaze detection function according to the present invention, the image display unit that displays a character and a camera that images the eyes of the user are included to detect the gaze of the user and calculate a portion that the user views in the displayed image.

Thus, if the gaze of the user is directed to a specific portion of the character displayed on the image display unit within a predetermined time, and, particularly, if the user views the eyes of the character or the vicinity of a center of the face, the communication is determined to be appropriately performed.

Therefore, a simulation closer to real communication than a simulation of communication of the related art without a gaze input step is performed.

In the simulation of communication, the direction sensor that detects the direction of the face of the user is included, and the direction of the face of the user is analyzed by the direction sensor to determine that the face of the user, as well as the gaze of the user, is directed to the character.

Therefore, when the user changes the direction of his or her face, an image can be changed according to the direction of the face of the user. Further, communication is determined to be performed only when the face of the user is directed toward the character. Thus, it is possible to perform more accurate simulation of communication.

If the image display unit and the camera are stored in the housing fixed to the head of the user, and the display device is an HMD as a whole, an HMD technology of the related art can be applied to the present invention as it is, and it is possible to display an image at a wide angle in a field of view of the user without using a large screen.

### BRIEF DESCRIPTION OF DRAWINGS

FIG. 1 is a simplified flow diagram of an algorithm for a focus recognition function of the present invention.

FIG. 2 is a flow diagram of an algorithm for a focus recognition function of the present invention.

FIG. 3 is a flowchart of a simulation.

FIG. 4 is a mounting diagram of an HMD type display device with a gaze detection function that is a first embodiment of the present invention.

FIG. 5 is a mounting diagram of an eyeglass type display device with a gaze detection function that is a second embodiment of the present invention.

FIG. 6 is a structural diagram of the present invention that images both eyes of a user.

### DESCRIPTION OF EMBODIMENTS

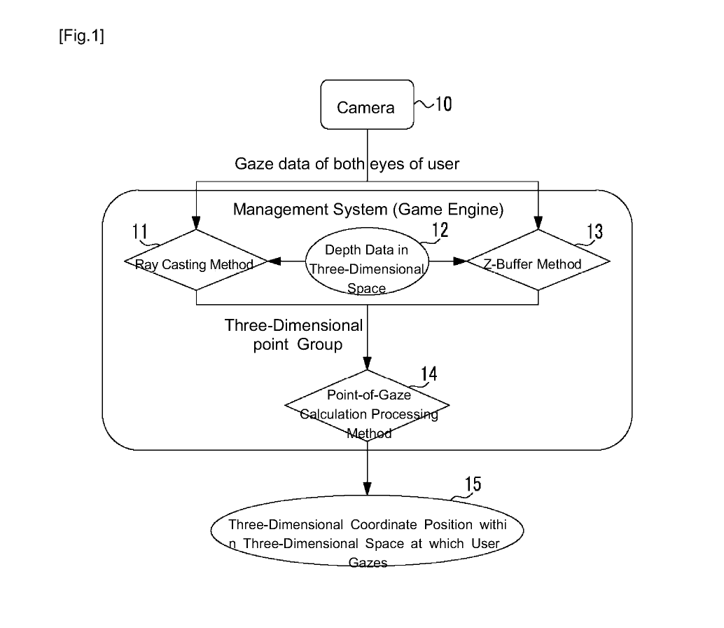

FIG. 1 is a simplified flow diagram of an algorithm for a focus recognition function of the present invention.

A camera 10 images both eyes of a user and calculates gaze data. Then, the gaze data is collated with depth data 12 within a three-dimensional space within a game engine using a ray casting method 11 or a Z-buffer method 13, a point-of-gaze is calculated using a point-of-gaze calculation processing method 14, and a three-dimensional coordinate position within a three-dimensional space at which a user gazes is identified.

The camera 10 images both eyes of the user, calculates a shortest distance point or an intersection point between lines of view of both eyes of the user, and refers to a Z-buffer value of an image portion closest to the shortest distance point or the intersection point between the lines of view of both eyes of the user. Blurring is applied to other image portions according to difference between the Z-buffer value and Z-buffer values of the other image portions.

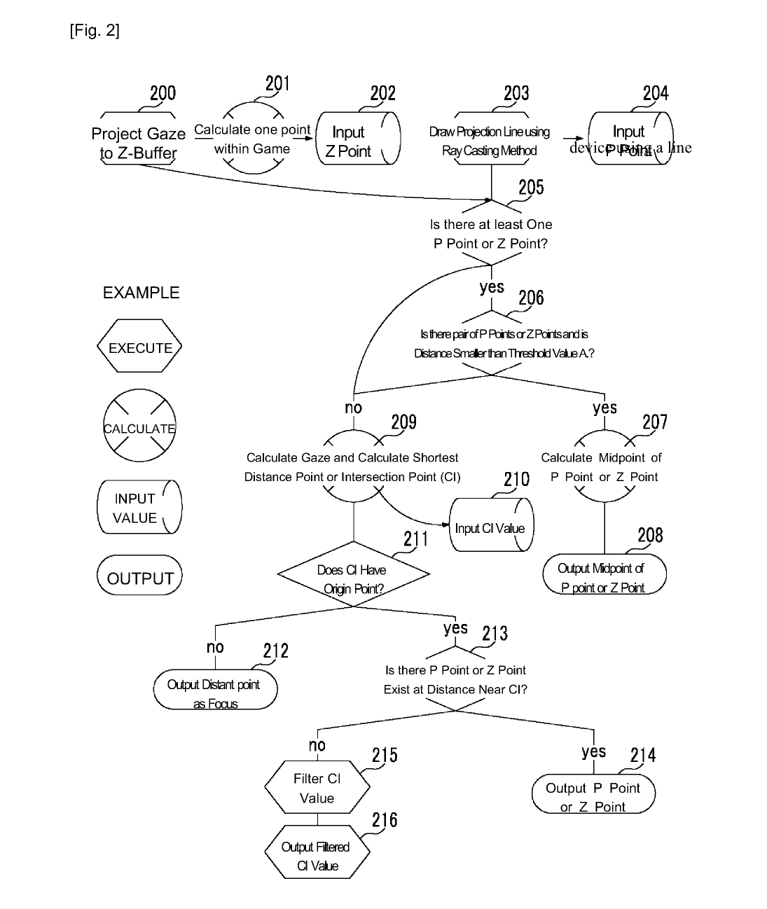

FIG. 2 is a flow diagram illustrating the algorithm in FIG. 1 in greater detail. First, one point within the game is input using a Z-buffer method or a ray casting method.

In the Z-buffer method, a gaze of a user is projected to an object within the game in which a Z-buffer value has been set (200), and coordinates of a point set as a surface of the object within the game are calculated (201) and input as a Z point (202).

In the ray casting method, a projection line is drawn in the three-dimensional space within the game engine (203), and coordinates of an intersection point between the gaze and the object in the game are input as a P point on a physical line within the game (204).

It is determined whether or not the P point or the Z point is at least one point (205). Further, if there is at least one match point, it is determined whether or not there are two match points and the distance between the two points is smaller than a threshold value a (206). If the match points are two points and the distance between the two points is smaller than a, a midpoint 207 between the two points or an important point of the two points is output as a focus (208).

On the other hand, if a point at which the P point and the Z point match is one point or less or a distance between two points is equal to or larger than a threshold value α even when the match points are the two points, a shortest distance point or an intersection point (CI) between lines of view of both eyes is calculated (209) and input (210).

It is determined whether or not the CI has an origin point (211). If the CI does not have an origin point, the focus is assumed not to be determined and a point distant from a value of the focus is output (212).

On the other hand, if the CI has an origin point, it is determined whether or not the Z point is in a range in the vicinity of the CI (213). If the Z point is in the range in the vicinity of the CI, the Z point is output as the focus (214). If the Z point is not in the range in the vicinity of the CI, filtering (215) is applied to the CI, blending is applied to a filtered value, and a resultant value is output (216).

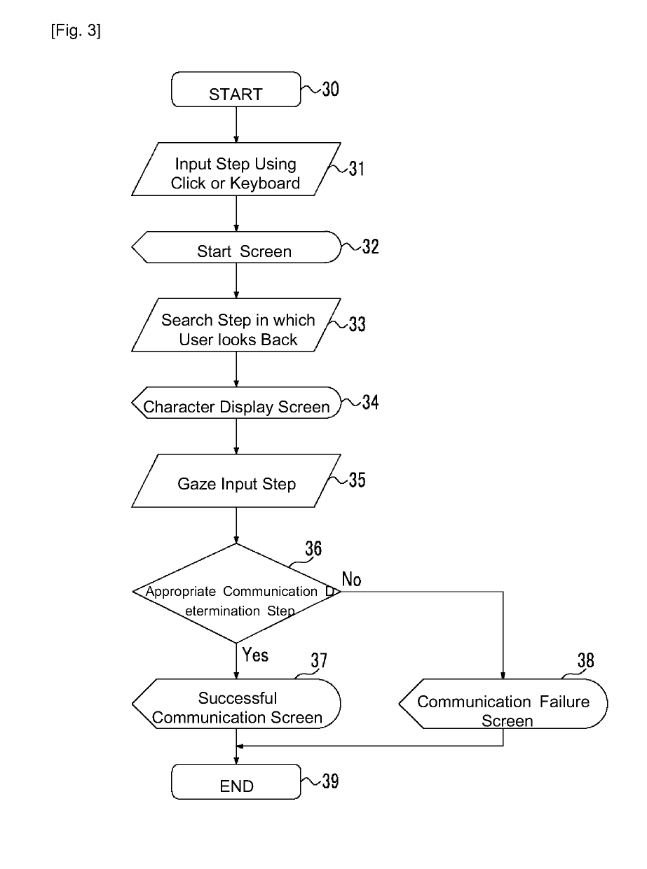

FIG. 3 is a flowchart of a simulation of communication in a display device with a gaze detection function according to the present invention.

In FIG. 3, the simulation is started by input step 31 by click or a keyboard after the simulation starts up, and a transition to a start screen 32 is performed.

A transition from the start screen 32 to an end 39 of the simulation is performed via a character search step 33 by the user, a character display screen 34, an input step 35 by the gaze of the user, an appropriate communication determination step 36, and a communication success screen 37 or a communication failure screen 38.

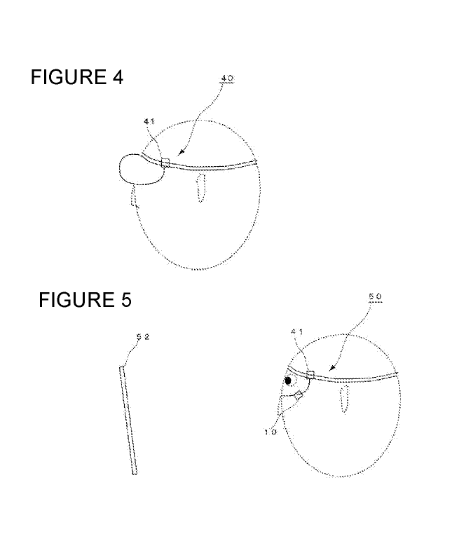

FIG. 4 is a mounting diagram in the first embodiment of the present invention. A display device with a gaze detection function 40 includes a sensor 41 that detects a direction of a face, and an image display unit and the camera 10 are stored in a housing that is fixed to the head of the user. The display device is an HMD type as a whole.

FIG. 5 is a mounting diagram in a second embodiment according to the present invention. For a display device with a gaze detection function, an image display device other than an HMD, such as a monitor for a personal computer, is used. The display device is an eyeglass type as a whole. In a character search screen, the user operates a focus displayed on the image display device by operating a mouse or a keyboard and performs search.

In the second embodiment, an image of the eyes captured by the camera 10 and information of the sensor 41 that detects the direction of the face are analyzed, and the gaze of the user is analyzed.

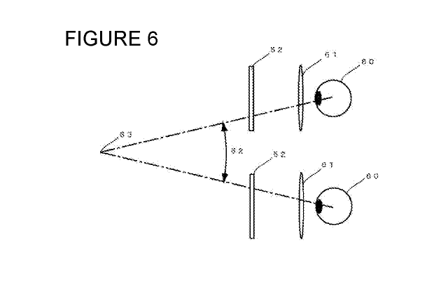

FIG. 6 is a structural diagram illustrating the camera 10 imaging both eyes. Coordinates in a space of a shortest distance point or an intersection point 63 between the gaze of the user are calculated according to parallax 62.

For example, in step 36 of determining communication, it is determined that the user communicates with the character on the basis of the coordinates of the shortest distance point or the intersection point 63 being directed to a specific portion of the character displayed on the image display unit for a predetermined time or more.

The sensor 41 that detects a direction of the face of the user is included. The direction of the face of the user is analyzed by the sensor 41. If the gaze of the user and the direction of the face are directed to a specific portion of the character displayed on the image display unit for a predetermined time or more, the user is determined to communicate with the character.

In the character search step 33 when the present invention is implemented, if the user changes the direction of his or her face, a displayed screen changes according to the direction of his or her head. Thus, an event in which a field of view reflected in the eyes when the direction of the face changes in a real space changes is reproduced in image representation by the HMD.

In the character search step 33, since the time of start is set to a time at which the character is outside the field of view, the character is not displayed on the screen, but the character is displayed together with a change in a background image due when the user looks back.

The camera 10 in the present invention is a small camera that images the eyes of the user, and the gaze of the user is calculated using an image captured by the camera 10.

In the simulation according to the present invention, a gaze of the user is a main input element of the simulation.

In the gaze input step 35, the gaze of the user from the camera 10 is analyzed and a result of the analysis is input as gaze data.

In step 36 of determining the communication, if the gaze of the user is directed to a specific portion of the character displayed on the image display unit for a predetermined time or more, the user is determined to communicate with the character.

In step 36 of determining the communication, the character looks at the user for about 15 seconds.

If the gaze of the user is directed to the vicinity of a center of the face of the character for about one second or more within the about 15 seconds, communication is determined to be successful.

On the other hand, if 15 seconds have elapsed in a state in which the gaze of the user is not directed to the vicinity of the center of the face of the character for one second or more, communication is determined to fail.

Further, if the gaze of the user moves too rapidly or if the user gazes at the character for too long, communication is determined to fail.

In the screen 37 when the communication is successful, the character greets the user. On the other hand, in the screen 38 when the communication fails, the character does not greet the user but merely passes by the user.

An adjustment procedure is provided for accurate gaze input before the simulation starts.

In the present invention, for input by the gaze, a direction of the gaze of the user is calculated from an image of the pupils captured by the camera. Here, the calculated gaze is calculated by analyzing the image of the eyes 40 of the user, but a difference between the calculated gaze and an actual gaze of the actual gaze of the user may occur.

Therefore, in a procedure for adjusting the difference, the user is caused to gaze at a pointer displayed on the screen, and a difference between a position of the actual gaze of the gaze of the user and a position of the calculated gaze is calculated.

Thereafter, in the simulation, a value of the calculated difference is corrected with the position of the calculated gaze, and a position of a focus recognized by the device is fitted on a point at which the user actually gazes.

### REFERENCE SIGNS LIST

10 Camera
11 Ray casting method
12 Depth data in three-dimensional space
13 Z-buffer method
14 Point-of-gaze calculation processing method
15 Coordinate position within three-dimensional space at which user gazes
200 Project gaze to Z-buffer
201 Calculate Z point within game
202 Input Z point
203 Draw projection line using ray casting method
204 Input P point
205 Is there at least one P point or Z point?
206 Is there pair of P points or Z points and is distance smaller than threshold value α?
207 Calculate midpoint of P point or Z point
208 Output midpoint of P point or Z point
209 Calculate gaze and calculate shortest distance point or intersection point (CI)
210 Input CI value
211 Does CI have origin point?
212 Output distant point as focus
213 Is there P point or Z point at distance near CI?
214 Output P point or Z point
215 Filter CI value
216 Output filtered CI value
30 Start
31 Start input step
32 Start screen
33 Search by user
34 Character display screen
35 Gaze input step
36 Communication determination step
37 Successful communication screen
38 Communication failure screen
39 End of simulation
40 HMD type display device with gaze detection function
41 Sensor that detects direction of face
50 Eyeglass type display device with gaze detection function
52 Screen
60 Eyes
61 Lens
62 Parallax
63 Shortest distance point or intersection point

1. A point-of-gaze calculation algorithm, comprising:
calculating data of lines of view of both eyes of a user using data from a camera that images the eyes of the user, and collating the calculated data of the lines of view with depth data of a three-dimensional space managed by a game engine using a ray casting method or a Z-buffer method; and
calculating a three-dimensional coordinate position in the three-dimensional space at which the user gazes.

2. The point-of-gaze calculation algorithm according to claim 1, comprising:
introducing focus representation in a pseudo manner by applying blur representation with depth information to a scene at the coordinates using three-dimensional coordinate position information identified by the gaze detection algorithm.

3. The point-of-gaze calculation algorithm according to claim 1,
wherein a target of interaction is displayed, and
the point-of-gaze calculation algorithm comprises
determining that the user interacts with the target when a gaze and a focus of the user are directed to a specific portion of the target for a predetermined time or more.

4. The point-of-gaze calculation algorithm according to claim 1, comprising:
calculating a direction of the face of the user using data from a direction sensor that detects the direction of the face of the user; and
determining that the user interacts with the target when the gaze of the user and the direction of the face match a specific portion of the target displayed on the image display unit for a predetermined time or more.

5. The point-of-gaze calculation algorithm according to claim 1, comprising:
calculating a direction of the face of the user using data from a direction sensor that detects the direction of the face of the user; and
determining that the user interacts with the target when the gaze of the user and the direction and a position of the face match a specific portion of the target displayed on the image display unit for a predetermined time or more.

6. A head-mounted display, comprising:
an image display unit; and
a camera that captures an image of the eyes of a user,
wherein the image display unit and the camera are stored in a housing fixed to the head of the user, and
the point-of-gaze calculation algorithm according to claim 1 is incorporated.
